(19) United States
(12) Patent Application Publication
(10) Pub. No.: US 2008/0190896 A1
(43) Pub. Date: Aug. 14, 2008

(54) Large Kitchen Professional Electrical Apparatus With Adaptive Feeding

(75) Inventors: Michel Georges Foray, Passenans (FR); Robert Fernand Bujeau, Charbuy (FR)

Correspondence Address: THOMPSON HINE LLP;Intellectual Property Group, P.O Box 8801, DAYTON, OH, 45401-8801, US

(73) Assignee: PREMARK FEG L.L.C., Wilmington, DE (US)

(21) Appl. No.: 11/911,857

(22) PCT Filed: Apr. 18, 2006
(86) PCT No.: PCT/US06/14884

§ 371 Date: Oct. 18, 2007

(30) Foreign Application Priority Data
Apr. 22, 2005 (FR) 0504050

(51) Int. Cl. H05B 3/02

(52) U.S. Cl. 219/50

(57) ABSTRACT

The appliance includes heating means comprising at least one electrical resistor (1-8) having a given rated power and connected to the output of a static contactor (101-103, 201-203) connected to control means and designed to be connected at the input to a phase conductor (91-93) of an electrical network (9) for supply of the resistor with alternating current and at a certain voltage. The control means are arranged to control the static contactor (101-103, 201-203) and break the supply current of the resistor so as to keep the apparent power of the resistor (1-8) substantially equal to its rated power.

The invention applies to ovens.

The invention arose from a problem with large-scale professional catering ovens, mentioned below, but a problem which concerns only the power supply to their electric heating resistors. However, many other appliances are equipped with electric resistors, so that the invention of the present application in fact concerns any large-scale professional electrical catering appliance, hence such as, also by way of example, a baking tunnel, a smoking cell, a deep frier, a washing machine, etc.

To get back to ovens, convection-heating ovens with heating resistors and convection fans are known. Also known are steam-heating ovens with, outside the cavity, a steam generator including heating resistors or, inside the cavity, heating resistors onto which water is sprayed to produce steam. Also known are combination ovens, with double heating by convection and steam, not to mention ovens which also allow microwave heating.

The invention also arose from a difficulty of power supply to these heating resistors.

Three-phase electrical supply systems have numerous well-known advantages, and they have long been established. A three-phase distribution network includes phase conductors and, if occasion arises, a neutral conductor, which can be dispensed with in the case of balanced star connection, in which the loads are as it were identical. The problem with three-phase networks is that the phase-to-phase voltage which they exhibit between the phase conductors taken in twos varies from one country to another. The same therefore applies to the phase voltage with one of the phase conductors and the floating neutral conductor.

For example, in Europe, the phase-to-phase voltage of a star connection is 400 V corresponding to a phase voltage of 231 V, and in the United States the phase-to-phase voltages are 480 V (phase voltage of 277 V), 240 V or 208 V and, on naval buildings, 440 and 254 volts.

For manufacturers it is therefore a problem of cost and time for supply and storage of resistors, which, if it were not properly solved, would risk, due to excessively high apparent power, making the installations trip and causing breakdown of the resistors.

Thus, by way of example, if we consider a resistor R having a power P of 100 W at a voltage U of 208 V, connected in an American star connection (U=277 V), the apparent power P′ would be too high. If we consider the current I which would have to pass through this resistor, the following relationships can be written:

$$P = UI$$

$$U = RI$$

$$Hence R = \frac{U}{I}$$

$$that is , R = \frac{U}{P / U}$$

$$R = \frac{{U}^{2}}{P}$$

$$R = \frac{{( 208 )}^{2}}{1000}$$

In the above relationship, we obtain:

$${P}^{′} = \frac{{U}^{′ 2}}{R}$$

$${P}^{′} = 1000 {( \frac{277}{208} )}^{2}$$

$${P}^{′} = 1774 V$$

The apparent power is therefore nearly double the normal power.

It will be noted here, finally, that the scope of the application may extend beyond solving the problem of three-phase networks and that the problem with any single-phase or multi-phase network would be the same.

The applicant therefore tried to solve the problem of keeping constant the apparent power of an electrical resistor of a large-scale professional catering appliance, independently of the voltage, in other words to adapt any voltage to a given resistor with constant power.

It is owing to the present special control of these resistors, by static contactors electronically controlled by microprocessor, that the applicant had the idea of its invention.

Thus the invention concerns a large-scale professional electrical catering appliance including heating means comprising at least one electrical resistor having a given rated power and connected to the output of a static contactor connected to control means and designed to be connected at the input to a phase conductor of an electrical network for supply of the resistor with alternating current and at a certain voltage, an appliance characterised in that the control means are arranged to control the static contactor and break the supply current of the resistor so as to keep the apparent power of the resistor substantially equal to its rated power.

The appliance of the invention is therefore an appliance with adaptive power supply.

It will be noted that the current-breaking frequency will depend on the conditions imposed by the electricity producer, on the one hand, and the specifications of the resistor, on the other hand.

In a preferred embodiment of the appliance of the invention, it comprises a plurality of convection resistors with three star-connected cores and a plurality of boiler resistors with three star-connected cores, respectively connected to static contactors including one which is common, via one of their cores, to all convection resistors and all boiler resistors.

The invention will be better understood with the aid of the following description of the electrical circuit of a large-scale professional catering oven with reference to the attached drawings, in which

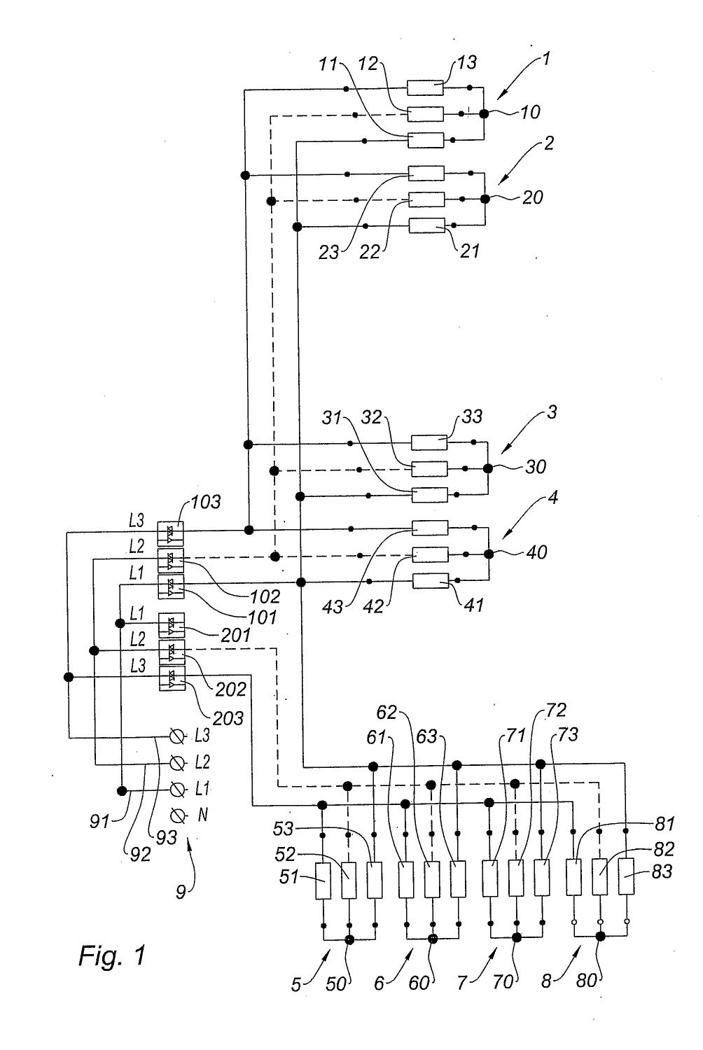

FIG. 1 shows the heating resistor circuit portion and

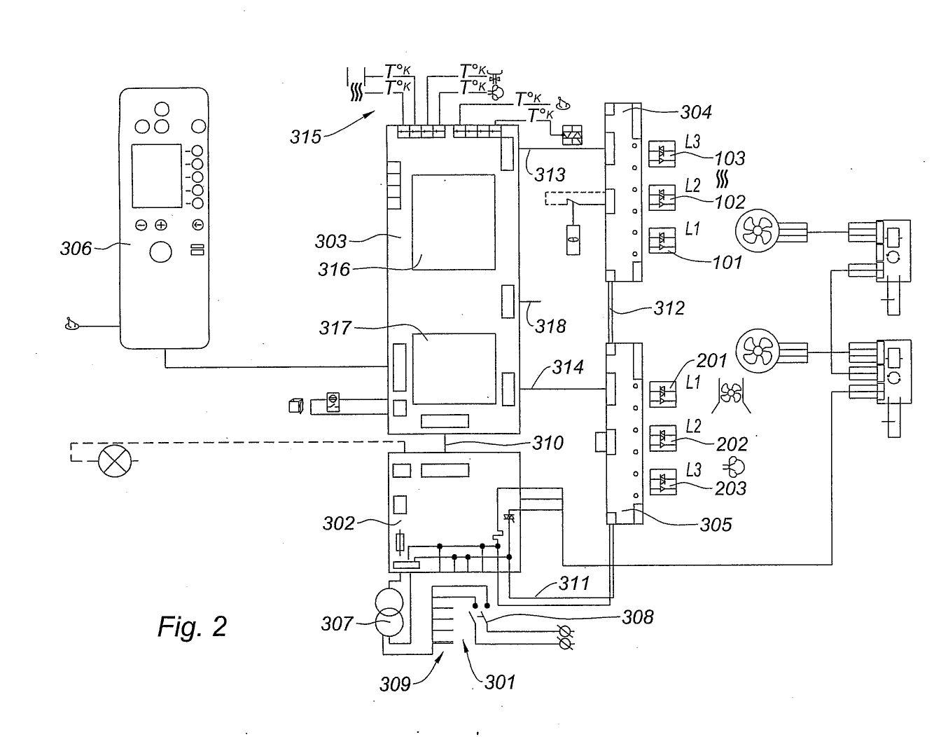

FIG. 2 shows the power supply and control circuit portion.

The circuit shown here is that of a combination oven with double heating by convection and steam, of relatively large size, in this particular case an oven with twenty levels distributed over two zones, one high and one low.

Each heating zone (FIG. 1) here comprises two convection resistors (1, 2) and (3, 4) with three cores each (11, 12, 13), (21, 22, 23), (31, 32, 33) and (41, 42, 43) respectively.

The boiler of the oven comprises four immersion heaters, that is, four boiler resistors (5, 6, 7, 8) with three cores each (51, 52, 53), (61, 62, 63), (71, 72, 73) and (81, 82, 83).

The oven is here supplied with alternating current from three phase conductors (91, 92, 93) of a three-phase network 9.

The three cores of each resistor are star-connected, each between a floating neutral conductor (10, 20, 30, 40, 50, 60, 80) respectively and one of the static contactors of two groups of three contactors (101, 102, 103) and (201, 202, 203).

Each static contactor of the first group 101-103 is connected at the output to one of the cores of the four convection resistors.

The contactor 101 is also here connected at the output to one of the cores of the four boiler resistors. The other two cores of each of the four boiler resistors are respectively connected to two (202, 203) of the contactors of the second group 201-203. At the input, the contactors of each group are connected respectively to the three phase conductors 91-93.

In the example under consideration, the contactor 101 of the first group is therefore common to the convection resistors and to the boiler resistors via one of the cores.

The power supply and control circuit (FIG. 2) comprises a transformer station 301, a power supply card 302, a microprocessor control card 303, relay cards 304 and 305 and a control console 306.

Not shown in the drawings are the oven components other than those which have been introduced above and which have no role, in the invention, such as the fans, the lighting, the ventilation hood, the pump and, if occasion arises, the elements of the microwave part of the oven.

The transformer station 301 is connected at the input to two phase conductors supplying a given supply voltage, 208 volts in the example under consideration. The transformer station has the function of transforming this voltage to a voltage, 230 volts here. Between the input and the transformer 307 is located a protective circuit breaker 308 connected to the transformer at its output OV and one of the five other outputs 309 corresponding to the various possible supply voltages.

The power supply card 302 is supplied from the output of the transformer 307 in order in turn to supply, here at voltages of 5, 24 and 230 volts, via cables 310 and 311 and 312 to a plurality of conductors, the control card 303, the relay cards (304, 305) and the other elements mentioned above.

The control card 303 is connected to the control console 306, to the relay cards (304, 305) via connecting cables (313, 314), as well as to a group of temperature sensors 315. This control card 303 here comprises a first microprocessor 316 for control of the relays and a second microprocessor 317 for management of the console 306. It will be noted that the control card 303 may also control a microwave relay card via a cable 318.

As far as the relay cards 304, 305 are concerned, they are mounted on the two groups of static contactors 101-103 and 201-203 respectively, the electrical contacts being provided by the printed circuits of the cards, on the one hand, and the locking screws of the contactors on the cards, on the other hand.

Lastly, the relays of the cards (304, 305) are designed to distribute the supply voltages to the different functional elements such as pumps, solenoid valves and, naturally, the static contactors.

The static contactors, here with thyristor, are controlled by the microprocessor 316 to break the current supply of the cores of the heating resistors 1-8 cyclically during a part of the cycles in order to keep their apparent power constant. As the rated power is known and the apparent power can be calculated according to the above relationships, anyone skilled in the art will be able to develop the software flow chart and the program for control of the contactors in order to achieve this adapted power supply. The established program is stored in a memory implanted on the control card 303. This program in fact aims to cut part of the alternations of the supply current. To resume the example considered above of a rated resistor of 1000 W at 208 V, at 277 V, the apparent power will be 1774 W. Owing to the invention, this apparent power is caused to drop 43.6%.

The program for cutting off the power supply will be determined by the characteristics of the resistors and conditions imposed by the electricity producers.

Predetermined adjustments and control may be envisaged. Automatic adaptive controls by measurement of the different parameters, voltage, current and frequency may also be provided.

1. Large-scale professional electrical catering appliance including heating means comprising at least one electrical resistor having a given rated power and connected to the output of a static contactor connected to control means and designed to be connected at the input to a phase conductor of an electrical network for supply of the resistor with alternating current and at a certain voltage, wherein the control means are arranged to control the static contactor and break the supply current of the resistor so as to keep the apparent power of the resistor substantially equal to its rated power.

2. Electrical appliance according to claim 1, in which there are provided a plurality of convection resistors with three star-connected cores and a plurality of boiler resistors with three star-connected cores, respectively connected to static contactors including one which is common, via one of their cores, to all convection resistors and all boiler resistors.

3. Appliance according to claim 2, in which the control means includes a microprocessor for control of relays designed to distribute the supply voltages to the static contactors.

4. Appliance according to claim 3, in which the microprocessor is arranged to cut off the current supply to the heating resistors cyclically during a part of the cycles.

5. An electrical appliance, the appliance comprising a heating system comprising:
an electrical resistor having a given rated power;
a static contactor with an output connected to the electrical resister and an input for connection to a phase conductor of an electrical network for supply of the resister with alternating current at a certain voltage; and
a control connected to the static contactor, the control arranged to control the static contactor and break current to the resistor so as to keep the apparent power of the resister substantially equal to its rated power.
